(19) United States
(12) Patent Application Publication
(10) Pub. No.: US 2012/0312952 A1
(43) Pub. Date: Dec. 13, 2012

(54) SUPPORT DEVICE FOR A UTENSIL

(76) Inventor: David A. Girmscheid, Caledonia, WI (US)

(21) Appl. No.: 13/492,417

(22) Filed: Jun. 8, 2012

Related U.S. Application Data
(60) Provisional application No. 61/495,219, filed on Jun. 9, 2011.

(51) Int. Cl. A47G 23/00; B32B 37/12

(52) U.S. Cl. 248/346.11; 156/60

(57) ABSTRACT

A support device has a pad configured to support a utensil and to wick away a portion of a material that soiled the utensil, and an adhesive coupled to the pad, the adhesive configured to bind the pad to a support surface to resist motion from the utensil. In accordance with an alternative embodiment, an apparatus has a permeation resistant pad configured to support a utensil soiled with a material; an absorbent layer in communication with the permeation resistant pad, the absorbent layer configured to wick a portion of the material into the absorbent layer; a leak resistant backing adjacent the absorbent layer, the leak resistant backing configured to resist a support surface being soiled by the material; and an adhesive contactingly adjacent the teak resistant backing, the adhesive configured to bind the permeation resistant pad on the support surface to resist motion from said utensil.

### RELATED APPLICATIONS

The present application makes a claim of domestic priority to U.S. Provisional Patent Application No. 61/495,219 filed Jun. 9, 7011.

### SUMMARY

Various embodiments of the present invention are generally directed to a support device for a utensil, which may be soiled.

In accordance with various embodiments, an apparatus includes at least a utensil soiled with material, a plurality of geometrically consistent layers of absorbent and non-absorbent material mechanically joined into a pad structurally configured to accommodate the utensil, and a slip-resistant material applied to a support surface exterior surface of the pad. Preferably, the utensil interfacing exterior surface of the pad is formed from the non-stick, non-absorbent porous material, the slip-resistant material applied to the support surface exterior surface of the pad mitigates relative motion between the pad and a support surface when the slip-resistant material interacts with the support surface, the absorbent material wicks away a portion of the material that soiled said utensil, and the non-absorbent material shields the support surface from contact with the material that soiled the utensil when the soiled utensil is placed upon the utensil interface exterior surface of the pad.

In accordance with an alternative embodiment, an apparatus has a permeation resistant pad configured to support a utensil soiled with a material; an absorbent layer communication with the permeation resistant pad, the absorbent layer configured to wick a portion of the material into the absorbent layer; a leak resistant backing adjacent the absorbent layer, the leak resistant backing configured to resist a support surface being soiled by the material; and an adhesive contactingly adjacent the leak resistant backing, the adhesive configured to bind the permeation resistant pad on the support surface to resist motion from said utensil.

These and other features and advantages which characterize the various embodiments of the present invention can be understood in view of the following detailed discussion and the accompanying drawings.

### BRIEF DESCRIPTION OF THE DRAWINGS

FIG. 1 provides a side view of an exemplary support device for a utensil in accordance with some embodiments,

FIG. 2A-B illustrate top views of the support device of FIG. 1.

FIG. 3 depicts a partially exploded side view of the support device of FIG. 1.

FIG. 4A-B reveal a bottom view of the support device of FIG. 1.

FIG. 5 portrays a side view of an exemplary stack of support devices of FIG. 1.

FIG. 6 illustrates a partial cutaway bottom view of an exemplary support device.

FIG. 7 reveals a side view of an exemplary support device.

### DETAILED DESCRIPTION OF EXEMPLARY EMBODIMENTS

The present disclosure generally relates to a support device for a utensil, and more particularly to an apparatus for supporting a utensil that may be soiled, and a method for making the apparatus.

Utensils are used by users in a variety of situations. For example, a user uses various cooking utensils such as a spoon, ladle, etc. to prepare or serve food. When the user uses the utensil during cooking, reheating, stirring, serving, etc., there is a tendency for the utensil to become dirty or soiled. The material on the soiled utensil may create a mess when the user rests the utensil on a surface, such as the nearest cooking surface, countertop, tabletop, etc. Traditionally, a conventional style spoon rest is used to support the utensil, such as a cooking spoon.

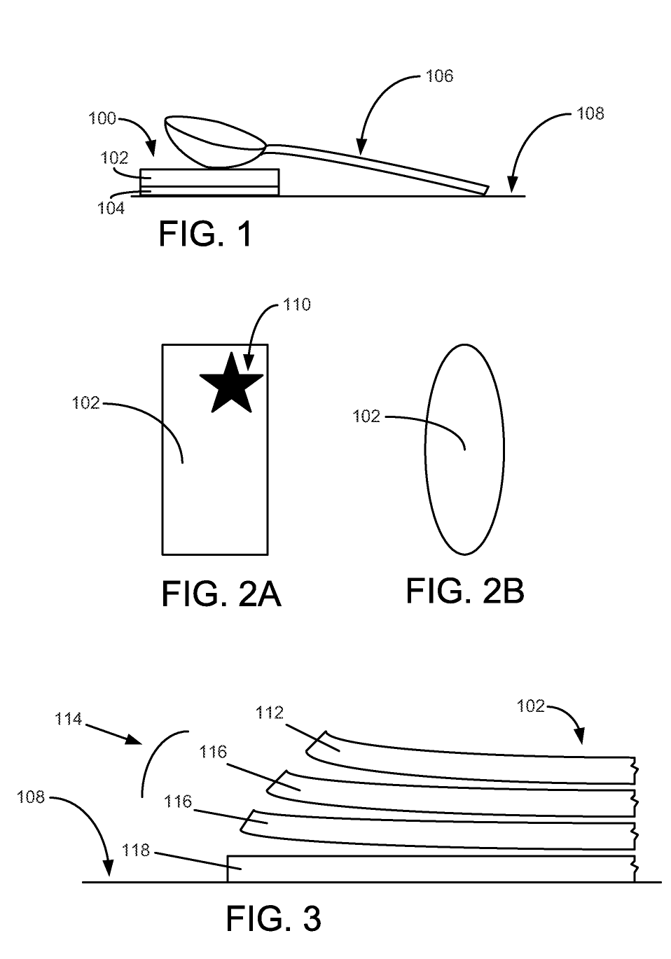

FIG. 1 generally illustrates an exemplary utensil support device 100. The support device 100 includes a pad 102 and a slip resistant material 104, also referred to herein as adhesive 104. In an exemplary embodiment, the pad 102 is preferably configured to support a utensil 106 and to wick away a portion of a material that soiled the utensil 106 when the soiled utensil 106 is placed upon the pad 102. The adhesive 104 is preferably applied to the pad 102 and configured to resist relative motion between the pad 102 and a support surface 108, particularly and preferably when the user places or displaces the utensil 106 on the pad 102.

FIG. 2A-B depicts the pad 102 may take a variety of shapes, such as oval, rectangle, or some other arbitrary predetermined shape, which may be appropriate for the utensil 106 to be supported. Exemplary size embodiments, but not by way of placing limitations upon the inventive pad 102, the inventive pad 102 may be ovals of approximately 5″×3.5″ for larger utensils, such as larger spoons, and 3.5″×2.5″ for smaller utensils. A rectangular shape for the pad 102, without imposing limitations on the present invention, may be useful for larger utensils, such as a spatula or a ladle, where the pad 102 size might range from 3″×5″ to 4″'6″. Of course, other sizes and shapes can be chosen based on the utensil 106 to be supported.

In addition, the pad 102 may present a decoration 110 of various patterns, designs, colors, names, etc. to accent a work space, such as a kitchen, or event surroundings. For example, the pad 102 may show holiday themes, advertisements, etc.

FIG. 3 illustrates the exemplary pad 102 may consist of several different layers or materials. For example, a permeation resistant layer 112 used to form a utensil support pad, which is also referred to herein as a permeation resistant pad, may support the utensil 106 in contacting adjacency. Permeation resistant materials may include a synthetic fluoropolymer of tetrafluoroethylene, such as spun Teflon®, although other permeation resistant materials may be utilized. The use of permeation resistant materials in forming the permeation resistant pad minimizes a tendency of soiled utensils 106 to stick to the pad 102. Preferably, the permeation resistant pad. further includes regions that promote the transfer of the material on the soiled utensil 106 to an absorbent layer 114 that is in communication with the permeation resistant pad.

In a preferred embodiment, the absorbent layer 114 is configured to wick a portion of the material soiling the utensil 106 into the absorbent layer 114, where that portion of the material may be retained. The absorbent layer 114 may consist of one or more plies 116, such as 2 plies with one ply being thicker, e.g., ¼ inch, than the other, e.g., less than ¼ inch. The absorbent layer 114 would be made of an absorbent type material much like the padding used to soak up liquid in the packaging of meat products. The absorbent layer 114 may be made from wood pulp fluff, fluff cellulose, cellulose wadding, cotton fibers, absorbent polymers, or other suitable absorbent materials known to those skilled in the art.

The absorbent layer 114, alone or in combination with gravity, might carry the material to the support surface 108. In a preferred embodiment, a leak resistant backing 118 is affixed adjacent the absorbent layer 114 and serves as a barrier to resist leakage of the material soiling the utensil 106 onto the support surface 108. For example, the leak resistant backing 118 made of plastic, or other suitable material, may keep the support surface 108 clean or dry.

In a preferred embodiment, the components of the pad 102 are sealed together by application of heat, ultrasonic vibrations or other suitable technique.

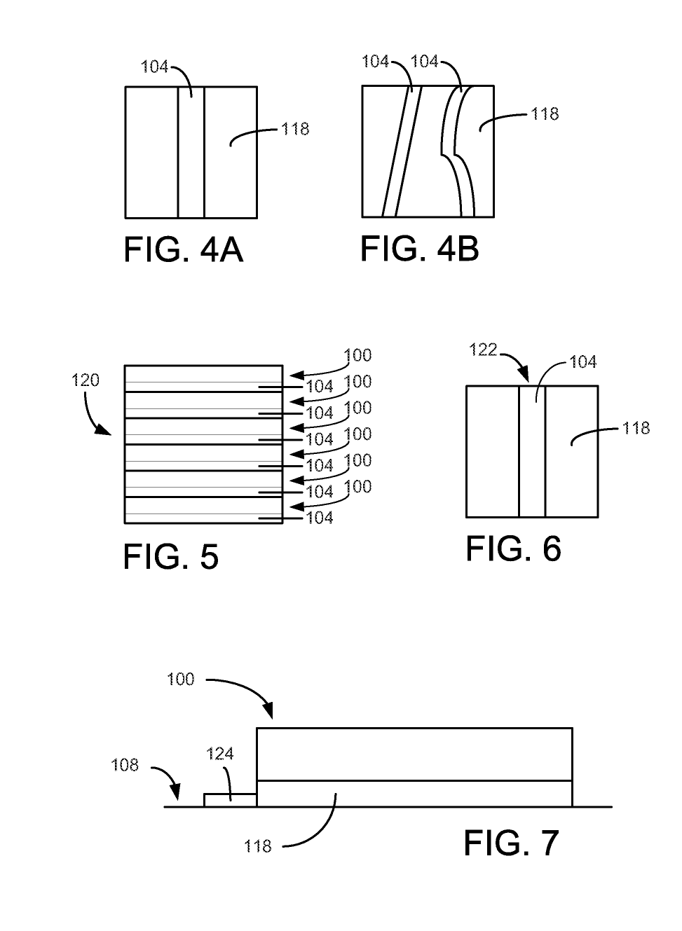

FIG. 4A shows the adhesive 104 may be contactingly adjacent the leak resistant backing 118. Just placing the support device 100 on a support surface 108 might not prevent the support device 100 from moving, particularly when the user places the utensil 106 on the support device 100 or removes the utensil 106 from the support device 100. The adhesive 104 may be configured to bind the permeation resistant pad on the support surface 108 to resist motion from the utensil 106.

The adhesive 104 may be various shapes and binding strengths. A single strip of the adhesive 104 may run substantially in the middle and lengthwise along the support device 100. For example, a one-inch wide strip of the adhesive 104 substantially down the center of the leak resistant backing 118 may be used.

With the various non-limiting configurations of the teak resistant backing 118, permeation resistant layer 112, and absorbent layer 114, any number of pads 102 can be packaged together for transport and distribution. One such manner of packing places a plurality of pads 102 on top of one another in a stack with the adhesive 104 of each pad 102 contacting the permeation resistant layer 112 of an adjacent pad 102. The permeation resistant layer 112 can be configured to resist adhesion with the adhesive 104 and allow easy removal of one or more pads 102 from the stack.

Another exemplary manner of packing pads 102 together rolls a plurality of pads 102 continuously about a central bore, such as a cardboard tube. The rolled pads 102 may be separate or continuously connected with removable sections joining edge portions of adjacent pads 102. The ability to contact the adhesive 104 of one pad 102 with the permeation resistant layer 112 of another pad 102 without activating the adhesive 104 and sticking allows a roll of pads 102 to be efficiently packed and dispensed. However, a protective adhesive cover may be inserted between some or all of the pads 102 in either the stack or rolled package to ensure the integrity of the adhesive 104 and highly efficient pad 102 removal.

In some embodiments, a stack or roll of pads 102 is sealed in a vessel that may take an unlimited number of sizes, shapes, and materials. For example, a stack or roll of pads 102 may be sealed in a sterile shrink-wrap environment. A stack or roll of pads 102 may alternatively be placed in a container with a predetermined shape, such as a plastic tub, that has a lid adapted for efficient removal of a single pad 102 from the stack or roll. A stack or roll may also be integrated into another instrument, such as a utensil container or trivet, which provides enhanced efficiency for use and storage of the pads 102.

FIG. 4B illustrates that alternatively a plurality of adhesives 104 may be used, or the adhesive 104 may take a variety of shapes.

The adhesive 104 may be strong enough to hold down the support device 100 even after multiple applications and removals from the support surface 108. For example, the adhesive 104 may be a Post-it® type “low tack,” reusable, pressure sensitive adhesive.

FIG. 5 illustrates when the adhesive 104 has a substantially “low tack” binding strength, the support device 100 can be readily formed into a stack 120, in which case the user can pull off the support device 100 from the stack 120, as needed.

FIG. 6 depicts that the adhesive 104 may be covered by a protective coating 122, such as a plastic film, etc. when the adhesive 104 binding strength is strong enough that in forming the stack 120 each of the support devices 100 could stick too well to the support device 100 in which it is in contacting adjacency. The protective coating 122 could prevent the support devices 100 from sticking together in the stack 120. When the user removes the support device 100 from the stack 120, the user simply removes the protective coating 122 to expose the adhesive 104, and the user may then use the support device 100 as discussed above.

FIG. 7 shows that to facilitate removal of the support device 100 from the support surface 108, the support device 100 may have a pulltab 124 that extends beyond the nominal borders of the leak resistant backing 118. The pulltab 124 would not be sticky or otherwise binding to the support surface 108. Alternatively, the leak resistant backing 118 may itself serve the role of the pulltab 124. If the single strip of the adhesive 104 is used, then the sides of the leak resistant backing 118 could be unsecured to the support surface 108, which should make for easy removal of the support device 100 from the support surface 108. If the binding strength of the adhesive 104 is of the predetermined appropriate strength, the pulltab 124 may not be required.

The support device 100 may be disposable, such that after use of each of the support devices 100, it may be thrown away.

An exemplary method of making a support device 100 for a utensil 106 has the steps of providing a pad 102 configured to support a utensil 106 and to wick away a portion of a material that soiled the utensil 106; and coupling an adhesive 104 to the pad 102, the adhesive 104 configured to bind the pad 102 to a support surface 108 to resist motion from the utensil 106.

An alternative exemplary method of making a support device 100 for a utensil 106 has the steps of providing a permeation resistant pad configured to support a utensil 106 soiled with a material; communicating an absorbent layer 114 with the permeation resistant pad, the absorbent layer 114 configured to wick a portion of the material into the absorbent layer 114; placing a leak resistant backing 118 adjacent the absorbent layer 114, the leak resistant backing 118 configured to resist a support surface 108 being soiled by the material; and affixing an adhesive 104 contactingly adjacent the leak resistant backing 118, the adhesive 104 configured to bind the permeation resistant pad on the support surface 108 to resist motion from the utensil 106.

Although, the exemplary embodiments of the present invention have been disclosed in the context of utensils for cooking, reheating, stirring, serving, etc. food, one skilled in the art will realize that the invention as claimed can be used in other environments, such as workshops, laboratories, art studios etc.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the various embodiments of the present invention to the full extent indicated by the broad general meaning of the terms in which the appended claims are expressed.

What is claimed is:

1. An apparatus comprising:
a utensil soiled with material;
a plurality of geometrically consistent layers of absorbent and non-absorbent material mechanically joined into a pad structurally, the pad supports the utensil; and
a slip-resistant material applied to a selected exterior surface of the pad, the selected exterior surface of the pad formed from the non-absorbent material, the slip-resistant material mitigates relative motion between the pad and a support surface when the slip-resistant material interacts with the support surface, wherein the support surface is selected from a group consisting of: a stove top; a countertop; a shelf; and a cutting board.

2. The apparatus of claim 1, in which the selected exterior surface is a bottom surface, and in which a top surface of the plurality of geometrically consistent surfaces is a non-stick, porous material.

3. The apparatus of claim 2, in which at least one layer of absorbent material is a wicking material.

4. The apparatus of claim 3, in which the wicking material is formed from a fibrous material, and wherein at least one layer of the fibrous material is in contact adjacency with the non-stick, porous material.

5. The apparatus of claim 4, in which the bottom surface is in contact adjacency with one layer of the fibrous material.

6. The apparatus of claim 5, in which the slip-resistant material is an adhesive material in contact adjacency with the bottom surface, wherein a holding strength of the adhesive interacting with the bottom surface is greater than a holding strength of the adhesive interacting with the support surface.

7. The apparatus of claim 6, in which the non-stick, porous material promotes passage of material soiling the utensil to the fibrous material, and wherein the fibrous material wicks away a portion of the material that soiled said utensil, and further wherein the utensil is a cooking utensil.

8. An apparatus comprising:
a permeation resistant material, said permeation resistant material supporting a utensil soiled with a material;
at least one absorbent layer in communication with the permeation resistant material, the absorbent layer wicks at least a portion of said material soiling said utensil through said permeation resistant material;
a leak resistant backing adjacent one of said at least one the absorbent layer, said leak resistant backing mitigates transfer of said material soiling said utensil to a support surface supporting said leak resistant backing; and
an adhesive contactingly adjacent said leak resistant backing, said adhesive interacting with said support surface to resist motion of said teak resistant backing relative to the support surface.

9. The apparatus of claim 8, in which said adhesive provides a holding strength when interacting with said leak resistant backing greater than a holding strength of said adhesive when interacting with said support surface.

10. The apparatus of claim 9, in which said support surface is selected from a group consisting of: a stove top; a countertop; a shelf; and a cutting board.

11. The apparatus of claim 10, in which said utensil is a food preparation utensil.

12. The apparatus of claim 11, in which said permeation resistant material, said at least one absorbent layer, and said leak resistant backing arc stacked together with said at least one absorbent layer disposed between said permeation resistant material and said leak resistant backing and mechanically joined at a perimeter of said stack to form a food preparation utensil support pad.

13. The apparatus of claim 12, in which said perimeter of said at least one absorbent layer is less than the perimeter of either said permeation resistant material and said leak resistant backing, such that a mechanical joint formed at an interface of said permeation resistant material and said leak resistant backing form a barrier to confine said at least one absorbent layer there within.

14. The apparatus of claim 13, in which said at least one absorbent layer is formed from a fibrous material.

15. The apparatus of claim 14, in which said fibrous material is selected from a group consisting of: wood pulp; cellulose; cotton; and absorbent polymers.

16. A method of forming a food preparation utensil support pad by steps comprising:
providing a permeation resistant material;
aligning at least one absorbent layer in contact adjacency with the permeation resistant material;
covering the at least one absorbent layer with a leak resistant backing;
applying an adhesive to the leak resistant backing;
affixing an adhesive to the leak resistant backing;
forming a confinement cavity by mechanically joining at least the leak resistant backing to the permeation resistant material to confine the at least one absorbent layer within the confinement cavity and form the food preparation utensil support pad; and
positioning the adhesive of the food preparation utensil support pad on a support surface.

17. The method of claim 16, in which said adhesive provides a holding strength when interacting with the leak resistant backing greater than a holding strength of the adhesive when interacting with the support surface.

18. The method of claim 17, in which the support surface is selected from a group consisting of a stove top; a countertop; a shelf; and a cutting board.

19. The method of claim 18, in which the utensil is a food preparation utensil. The method of claim 19, in which the permeation resistant material, the at least one absorbent layer, and the leak resistant backing are stacked together with the at least one absorbent layer disposed between the permeation resistant material and the leak resistant backing and mechanically joined at a perimeter of the stack to form absorbent layer is less than the perimeter of either the permeation resistant material and the leak resistant hacking, such that a mechanical joint formed at an interface of the permeation resistant material and the leak resistant backing form a barrier to confine the at least one absorbent layer there within.
